(19) United States
(12) Patent Application Publication
(10) Pub. No.: US 2025/0190916 A1
(43) Pub. Date: Jun. 12, 2025

(54) Information Technology Framework For Measuring Performance of Business Capabilities of an Enterprise

(71) Applicant: T-Mobile Innovations LLC, Overland Park, KS (US)

(72) Inventors: Robert G. Brewster, Spokane, WA (US); Sanjay Laxman Kharate, Sammamish, WA (US); Loren J. Miller, Snohomish, WA (US)

(21) Appl. No.: 18/534,345

(22) Filed: Dec. 8, 2023

(51) Int. Cl. G06Q 10/0639; G06Q 10/0631; G06Q 10/0637

(52) U.S. Cl. CPC G06Q 10/06393; G06Q 10/06313; G06Q 10/06375

(57) ABSTRACT

A system comprises a first user equipment (UE), a second UE, an application server, and a strategic performance measurement server. The first UE is configured to generate an initiative in an enterprise tool of an application server; transmit a request for a strategic dashboard scorecard to a strategic performance measurement server; and receive the strategic dashboard scorecard. The second UE is configured to receive a request for creating configuration information for the initiative from the enterprise tool; create the configuration information for the initiative in response to receiving the request; and transmit the configuration information to the strategic performance measurement server. The application server is configured to receive the initiative from the first GUI; and transmit project progress data to a strategic performance measurement server. The strategic performance measurement server configured to assign a scoring value to the initiative; obtain the strategic dashboard scorecard; and transmit the strategic dashboard scorecard.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

An organization or a business enterprise may manage multiple initiatives that are spread across various business units of the organization. For example, business units may have quarterly or yearly initiatives (or projects) that enable deliverables and which are expected to meet enterprise goals. Each initiative may include one or more pre-set action blocks/steps that are to be completed by business capabilities/business functions of the organization, and achievement of the action steps determines a measure of progress by the business unit to meet the goals of the organization. Further, different business units of the organization may use multiple domain-specific enterprise software/tools to create initiatives and monitor ongoing action steps of these initiatives for measuring progress of the business unit implementing the initiatives. As action steps/tasks of an initiative are completed, project progress data is entered in real-time into one or more enterprise tools of the business unit. The project progress data is later collected and analyzed to determine performance of business capabilities in achieving the initiatives and progress to the strategic objectives or high-level goals of the organization. Further, the organization may monitor these initiatives in order to obtain a view as to the progress of the initiative towards business objectives or goals. However, these initiatives may not give the organization a complete or timely view as to whether the initiative was adequately supported with respect to investment, staffing resources, and operational decisions during implementation of the initiative.

### SUMMARY

In an embodiment, a system for an information technology framework for measuring performance of business capabilities for a key performance measure (KPM) of an enterprise comprises a first user equipment (UE), a second UE, an application server, and a strategic performance measurement server. The first UE is configured to generate, via a first graphical user interface (GUI), an initiative in an enterprise tool of an application server, wherein the initiative comprises action steps that are to be performed for implementing the initiative; transmit, via the first GUI, a request for a strategic dashboard scorecard to a strategic performance measurement server; and receive, via the GUI, the strategic dashboard scorecard responsive to transmitting the request, wherein the strategic dashboard scorecard comprises a business capability for the KPM, data associated with the business capability for the KPM, and the initiative. The second UE is configured to receive, via a second GUI, a request for creating configuration information for the initiative from the enterprise tool; create, via the second GUI, the configuration information for the initiative in response to receiving the request; and transmit, via the second GUI, the configuration information to the strategic performance measurement server. The application server is configured to receive the initiative from the first GUI; and transmit project progress data of the initiative to a strategic performance measurement server, wherein the project progress data comprises performance data that is obtained during implementation of the initiative. The strategic performance measurement server configured to assign a scoring value to the initiative; obtain the strategic dashboard scorecard responsive to assigning the scoring value; transmit, to the first user equipment, the strategic dashboard scorecard in response to the request for the strategic dashboard scorecard; analyze at least one of the project progress data and the data associated with the business capability for the KPM; and automatically transmit, to the enterprise tool, one or more revised action steps for a second initiative whereby the one or more revised action steps permit the enterprise to avoid delays in implementing the second initiative.

In another embodiment, a method for an information technology framework for measuring performance of business capabilities for a key performance measure (KPM) of an enterprise according to a business initiative comprises a first user equipment (UE), a second UE, an application server, and a strategic performance measurement server. The method comprises generating, via a first graphical user interface (GUI) of a first user equipment (UE), an initiative in an enterprise tool of an application server, wherein the initiative comprises action steps that are to be performed for implementing the initiative; transmitting, via the first GUI, a request for a strategic dashboard scorecard to a strategic performance measurement server; receiving, via the GUI, the strategic dashboard scorecard responsive to transmitting the request, wherein the strategic dashboard scorecard comprises a business capability for the KPM, data associated with the business capability for the KPM, and the initiative; receive, via a second GUI of a second UE, a request for creating configuration information for the initiative from the enterprise tool; creating, via the second GUI, the configuration information for the initiative in response to receiving the request; transmitting, via the second GUI, the configuration information to the strategic performance measurement server; receiving, by the application server, the initiative from the first GUI; transmitting, by the application server, project progress data of the initiative to a strategic performance measurement server, wherein the project progress data comprises performance data that is obtained during implementation of the initiative; assigning, by the strategic performance measurement server, a scoring value to the initiative; obtaining, by the strategic performance measurement server, the strategic dashboard scorecard responsive to assigning the scoring value; transmitting, by the strategic performance measurement server, the strategic dashboard scorecard to the first UE in response to the request for the strategic dashboard scorecard; analyzing, by the strategic performance measurement server, at least one of the project progress data and the data associated with the business capability for the KPM; and automatically transmitting, to the enterprise tool, one or more revised action steps for a second initiative whereby the one or more revised action steps permit the enterprise to avoid delays in implementing the second initiative.

In yet another embodiment, a system for an information technology framework for measuring performance of business capabilities for a key performance measure (KPM) of an enterprise according to a business initiative comprises a first user equipment (UE), a second UE, an application server, and a strategic performance measurement server. The first user equipment (UE) is configured to generate, via a first graphical user interface (GUI), an initiative in an enterprise tool of an application server, wherein the initiative comprises action steps that are to be performed for implementing the initiative; transmit, via the first GUI, a request for a strategic dashboard scorecard to a strategic performance measurement server; and receive, via the GUI, the strategic dashboard scorecard responsive to transmitting the request, wherein the strategic dashboard scorecard comprises a business capability for the KPM, data associated with the business capability for the KPM, and the initiative. The second UE is configured to receive, via a second GUI, a request for creating configuration information for the initiative from the enterprise tool, wherein the configuration information for the initiative comprises a KPM corresponding to at least one business capability of the enterprise, a performance measurement score for the KPM; a scoring factor applied to the initiative, and a scoring value derived for the initiative based on the scoring factor; create, via the second GUI, the configuration information for the initiative in response to receiving the request; and transmit, via the second GUI, the configuration information to the strategic performance measurement server. The application server is configured to receive the initiative from the first GUI; and transmit project progress data of the initiative to a strategic performance measurement server, wherein the project progress data comprises performance data that is obtained during implementation of the initiative. The strategic performance measurement server is configured to obtain a dashboard template; determine a scoring factor for obtaining a scoring value for the project process data; assign a scoring value for the initiative based on the scoring factor; input the scoring value to the dashboard template to obtain the strategic dashboard scorecard; transmit, to the first user equipment, the strategic dashboard scorecard in response to the request for the strategic dashboard scorecard; analyze at least one of the project progress data and the data associated with the business capability for the KPM; and automatically transmit, to the enterprise tool, one or more revised action steps for a second initiative whereby the one or more revised action steps permit the enterprise to avoid delays in implementing the second initiative.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a performance measurement system according to an embodiment of the disclosure.

FIG. 2 is a block diagram of a method of a strategic performance framework according to an embodiment of the disclosure.

FIG. 3 is a view of a scorecard according to an embodiment of the disclosure.

FIG. 4 is an illustration of a communication device according to an embodiment of the disclosure.

FIG. 5 is a block diagram of a hardware architecture of a communication device according to an embodiment of the disclosure.

FIG. 6 is a block diagram of a communication system according to an embodiment of the disclosure.

FIG. 7 is a block diagram of a core network of a communication system according to an embodiment of the disclosure.

FIG. 8 is a block diagram of software architecture of a communication device according to an embodiment of the disclosure.

FIG. 9 is a block diagram of another software architecture of a communication device according to an embodiment of the disclosure.

FIG. 10 is a block diagram of a computer system according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

An organization may implement initiatives across its various business units in order to meet the strategic goals of the enterprise. In an example, an initiative may be a strategic goal or objective of the enterprise, and may be a general goal such as becoming a top participant in a specific industry or increasing market share by 20%. A business unit may use multiple domain-specific enterprise software tools to run, scale, and optimize their day-to-day operations and processes, as well as build their own unique applications. In some examples, an enterprise software (also referred to as “enterprise tool”) may include project management software, customer relationship management (CRM) software, business intelligence software, enterprise communication software, inventory management software, marketing software, online payment software, enterprise resource planning software, collaboration software, enterprise resource planning software. In an example, a business unit of the enterprise (e.g., a division of the company) may apply enterprise software to create business or technology initiatives on a quarterly or annual basis and also obtain real-time project progress data having performance data that is obtained when implementing the initiative and that indicates how resources were consumed in completing the action steps and when the action steps are completed to close out the initiative. In an example, an initiative may include one or more action steps that are expected to be completed by different business functions/capabilities of the enterprise such as, e.g., business capabilities like marketing, sales management, IT management, human resource management, or the like. These initiatives may require different business capabilities to perform action steps of the initiative in order to perform the initiative so as to meet the goals/objectives of the enterprise, some of which may be strategic objectives of the enterprise.

However, business or technology initiatives, some of which may be critical to the success of an organization, may not show progress in meeting the strategic objectives of the enterprise. For instance, when initiatives are implemented, several different enterprise tools collect project progress data, but these different enterprise tools are not integrated with each other (e.g., enterprise tools may not share project progress data of initiatives that is collected). Therefore, a user of the organization may not have visibility into how business capabilities that support multiple initiatives are meeting the organization's strategic objectives or the level of improvement by the business capabilities. Further, some business or technological teams of a business unit operate as silos and may not share information and project progress data within other business or technological teams in other business units, which may waste valuable resources of the organization. As some of these enterprise tools are not integrated with each other, duplicate resources and effort are undertaken to implement the initiatives across the organization. Further, these business or technology initiatives may not provide adequate insight within the organization into how the different business capabilities are performing for multiple objectives at the same time as initiatives are completed/closed, which may hinder decision making by the organization. For instance, the organization may not be able to determine whether the initiative was adequately supported with respect to monetary investment, staffing resources, and/or operational decisions, or whether limited resources was a determinate factor in how the business capabilities performed in achieving the objectives. Further, performance scorecards for an initiative that are used for tracking and managing an organization's strategy may not be available across the different business units of the organization. Also, as the reporting requirements are specifically tailored for an initiative, management personnel of the organization may not be able to view performance scorecards that show how multiple dimensions of objectives are being impacted as different initiatives are implemented across various businesses across the organization.

As disclosed herein, user equipment (UE) or user device in the present application may transmit data requests to a strategic performance measurement (SPM) application in order to implement an information technology (IT) framework for an organization. In an example, the IT framework may obtain performance measurement scores or indicators for an organization to obtain performance measurement of a business capability for an organization. In examples, the SPM application may reside at a strategic performance measurement server and may receive data requests from UE devices of an administrator, a user associated with a business unit, or other stakeholder of the organization. In an example, the organization may be a healthcare organization, a manufacturing organization, a financial services organization, a telecommunications provider organization, or another similar type of organization. In an example, the performance measurement scores (also referred to as “performance indicators”) is obtained via a strategic performance measurement framework. The strategic performance measurement framework includes a strategic performance measurement (SPM) application that executes a strategic performance measurement (SPM) algorithm to obtain performance measurement of key performance measures (KPMs) for business functions/capabilities. In an example, the KPMs are the basic (key) markers of progress of the organization (e.g., a strategic objective) toward a target outcome and may be assessed through performance measurement scores. In an example, the SPM application may execute instructions of the SPM algorithm on project progress data in order to obtain performance measurement scores for KPMs (e.g., strategic objectives) of business capabilities of the organization. In an example, the performance measurement scores indicate whether the business capabilities/functions of an organization have improved over a pre-defined period of time as initiatives are implemented in the organization.

In an example, the SPM algorithm applies the scoring values that are derived from project progress data of initiatives that have been completed. In an example, the project progress data for implemented initiatives may be retrieved from a database that receives the project progress data from an enterprise software application/tool (also referred to as “enterprise tool”). Further, the strategic dashboard scorecard may display multiple dimensions of data including pre-defined KPMs for the organization, performance measurement scores of the business capabilities for the pre-defined KPMs, and the initiatives that have completed and their scoring values which indicate the value of the initiative to the organization. In an example, a UE of a user may transmit data requests for the strategic dashboard scorecard from a graphical user interface (GUI) of a client application to a strategic performance measurement server and may receive, in real-time, the strategic dashboard scorecard with the performance measurement scores for viewing on the GUI. In an example, the UE may transmit data requests for requesting a strategic dashboard scorecard with user-defined KPMs that are selected by the user from pre-defined dashboard templates or from user selectable dashboard templates (e.g., dynamically selected KPMs), and may receive, in real-time, the strategic dashboard scorecard with performance measurement scores for the dynamically selected KPMs. The disclosure described herein provides advantages over conventional solutions. The strategic performance measurement framework described herein is implemented to provide a strategic dashboard scorecard of business capabilities for KPMs of the organization that shows the level or degree of progress of the business capabilities for KPMs of the organization when initiatives are implemented in business units. In an example, the strategic dashboard scorecard may be standardized view for initiatives, KPMs scores and business capabilities for the entire organization that may provide quick insights into how business functionalities have performed in meeting the objectives of the organization. In an example, the strategic dashboard scorecard may provide visibility as to whether the initiative is adequately supported with respect to investment, staffing resources, and operational decisions for a combination of KPMs over a pre-defined time period. A strategic dashboard scorecard may include information that is presented in a standardized format for the organization and, as a result, a user from any business unit may efficiently understand the data being presented. Further, in an example, the user may request additional KPMs to be presented on the strategic dashboard scorecard via data requests that are transmitted to a centralized server, and may receive, in real-time, the strategic dashboard scorecard with the additional KPMs in the standardized format so that the user may not need manual and labor intensive reports to be generated by other users in the organization. In an example, a user of a business unit may access, in real-time, a strategic dashboard scorecard of KPMs that is standardized for a business unit based on KPMs that are commonly applied to the business unit. In an example, the SPM application may dynamically generate the strategic dashboard scorecard for diverse business units of the organization based on KPMs that are commonly used to measure performance at the corresponding business unit. Further, as enterprise tools within the organization store project progress data of initiatives into a shared database, any user may request, in real-time, a strategic dashboard scorecard for any number of initiatives being implemented from one application/tool, and may be able to get a comprehensive and accurate view of how the business capabilities of the corporation are performing for several KPMs with respect to various initiatives that are implemented in the corporation.

In an example, the strategic dashboard scorecard may enable the enterprise to identify a potentially latent bottleneck or an actual bottleneck in an early stage of implementation of an ongoing initiative. In an example, the bottleneck may be for an ongoing/existing initiative/project and may need additional resources for completion in a timely manner so as to add value to the strategic objectives/KPMs of the organization. In an example, the strategic dashboard scorecard may enable the enterprise to address the bottleneck by assigning additional resources and/or to determine whether the ongoing initiative is to be eliminated based on the performance measurement scores of KPMs for business capabilities that are obtained for completed initiatives. In an example, the SPM application may automatically revise/amend action steps of an ongoing initiative or add new action steps by assigning new resources or reallocating existing resources to action steps of an ongoing initiative. In an example, the SPM application may automatically push the amended initiative to business units for implementation via one or more enterprise tools. In an example, the SPM application may push the revised action steps for an amended and ongoing initiative to one or more enterprise tools for implementation without requiring project managers and other users to spend additional time and effort in identifying status of resources, time needed for completing action steps, and additional resources that are needed to avoid potential bottlenecks of an ongoing initiative in order to implement the initiative to add value to the organization.

In an example, the enterprise tools are integrated with each other and project progress data of initiatives that are created in one enterprise software application are shared with other enterprise software applications thereby avoiding the problems in conventional solutions where progress data in enterprise software applications is siloed and not shared across the enterprise. In an example, a user may create an initiative and define resources of one or more business capabilities of the organization (e.g., resources of a marketing function, a legal function, an IT function) to action steps of the initiative. In an example, an administrator may identify information for configuring dashboard templates, scoring factors to apply to an initiative, layout, and organization of elements for the strategic dashboard scorecard. In examples, the administrator may determine the layout of a strategic dashboard scorecard including the elements/objects to display, the strategic performance measurement model/algorithm that will be applied for obtaining performance measurement scores for the KPMs, how to display historical performance measurement scores including displaying performance trends on the improvements made by the business capabilities for KPMs over historical scores as project progress data changes for an initiative. In an example, the administrator may include KPMs that are generally well-known within the organization and/or KPMs that are widely used in the organization in the dashboard templates. In an example, the organization of the objects on the dashboard templates may define the layout of objects on the strategic dashboard scorecard. In an example, each user may receive a strategic dashboard scorecard that includes the user-defined KPMs that are specific to the business unit of the user so that the user, based on the user-defined KPMs, may be able to obtain real-time insights on initiatives that are directly related to the user's business unit and how the business capabilities are performing in respect to the business unit's initiatives.

In an example, the strategic dashboard scorecard provides users of the organization with visibility into progress of different business capabilities across the enterprises that overcomes the problems inherent in conventional solutions where different users of an enterprises may not have visibility into initiatives that are being implemented. For instance, the strategic dashboard scorecard disclosed herein may present a static view of initiatives that are planned and ongoing, scoring rules that are being applied to obtain scoring values for completed initiatives, and performance measurement scores that are applied to KPMs for business capabilities of the organization. In an example, the dashboard template is populated with the scoring values that are obtained for the initiatives, a performance measurement score for a KPM of a business capability for the current time period, performance measurement score for a KPM of a business capability for a prior time period, a target performance measurement score for a KPM of a business capability for the current time period, and a difference between a performance measurement score for a KPM of a business capability for the current time period and a performance measurement score for a KPM of a business capability for the previous time period that indicates the progress of business capabilities of the enterprise in implementing the different initiatives of the enterprise. In an example, the strategic dashboard scorecard may be displayed to each user on a GUI and may include initiatives and performance measures of the KPMs for the business capabilities of the organization and trend data that shows progress towards improvement of the business capabilities for the different KPMs that are presented on the strategic dashboard scorecard.

In an example, the SPM application may automatically send, to one or more enterprise tools, status information on resources that were consumed/used by a completed initiative and may instruct the enterprise tools to assign new resources/reallocate existing resources that are assigned to action steps and timelines of ongoing initiatives. In an example, the SPM application may analyze project progress data for a completed initiative and the strategic dashboard scorecard to determine whether business capabilities assigned to the completed initiative were bottlenecks during implementation of the completed initiative. In an example, the SPM application may automatically change/amend action steps of the ongoing initiative by assigning new resources/reallocating existing resources for action steps of an ongoing initiative within an enterprise tool to avoid bottlenecks in the ongoing initiative and may provide current progress reports of initiatives that are being implemented that overcomes the problems where progress data is not available to provide insights into adequate resources that are to be allocated to ongoing initiatives for conventional solutions. For instance, the SPM application may retrieve project progress data of ongoing/existing initiatives (e.g., initiatives that have not completed) and business capabilities that are assigned to action steps of ongoing initiatives and may automatically identify ongoing initiatives that use the resources of a business capability for the completed initiative during the analysis.

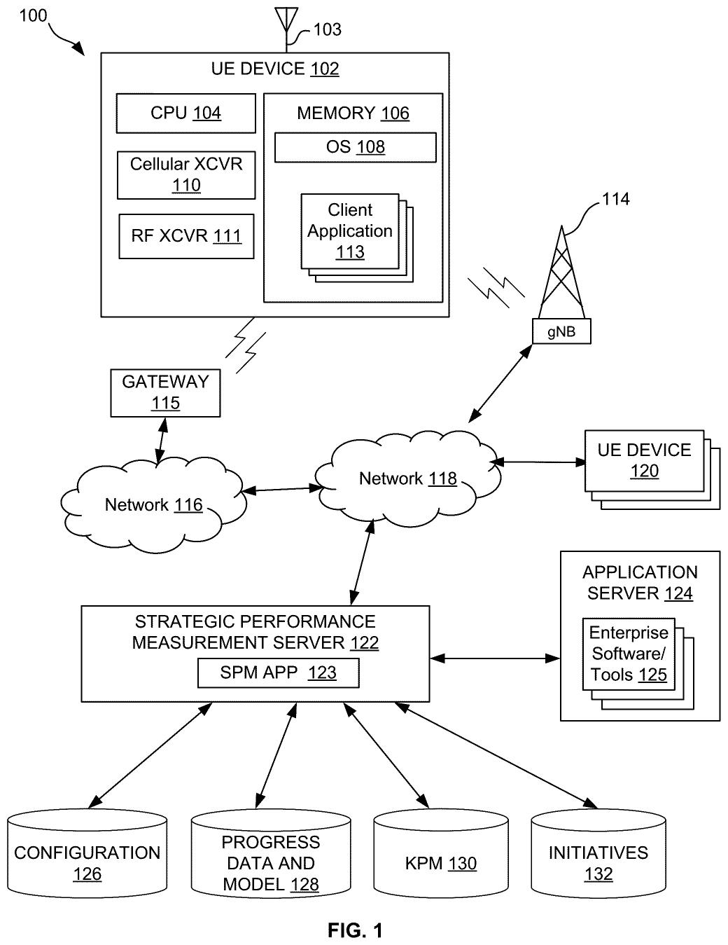

Turning now to FIG. 1, a performance measurement system 100 is described according to an embodiment. In an embodiment, the performance measurement system 100 implements a strategic performance measurement framework that measures the performance of a business functionality for KPMs of the organization when one or more business or technological initiatives are implemented by the business capability.

In an embodiment, the performance measurement system 100 may include user equipment (UE) device (or “computing device”) 102, a cell site 114, a wireless gateway 115, a first communication network 116, a second communication network 118, UE devices 120, a strategic performance measurement server 122, application server 124, a configuration database 126, a progress data and model database 128, key performance measure (KPM) database 130, and initiatives database 132. In an example, the UE 102 may be a communication device of a user that transmits a request to create a strategic dashboard scorecard. In examples, the UE 102 may be a smart phone, a tablet computer, a portable computer, a desktop computer, a wearable computer, a personal digital assistant (PDA), a headset computer, a laptop computer, a notebook computer, a tablet computer, and other computing devices that has one or more processors, one or more memories, and transceiver components.

The UE 102 may be a fixed communication device or a mobile communication device. In an embodiment, the UE 102 comprises an antenna 103, a central processing unit (CPU) 104, a memory 106 that stores an operating system (OS) 108, a cellular transceiver 110, a radio frequency (RF) transceiver 111, and one or more client applications 113. In an embodiment, the antenna 103 may be communicatively coupled to the cellular transceiver 110, the RF transceiver 111, and client applications 113 through a wired connection. The antenna 103 may include radio frequency (RF) reception and transmission components of the UE 102, and may be communicatively coupled to the cellular transceiver 110 and the RF transceiver 111.

In an embodiment, the cellular transceiver 110 may establish a radio communication link to the cell site 114 using the antenna 103. In an embodiment, the cellular transceiver 110 may establish the radio communication link to the second communication network 118 using the antenna 103. The radio communication link may be established according to a Long-Term Evolution (LTE) protocol, a Code Division Multiple Access (CDMA) protocol, a Global System for Mobile Communications (GSM) protocol, or a 5th generation mobile network (5G) telecommunication protocol. In an embodiment, the cellular transceiver 110 includes a 5G RAT that provides an air interface for the UE 102. While not shown in FIG. 1, the cellular transceiver 110 may include additional circuit components to process and manipulate wireless signals that are received from the cell site 114 at the UE 102.

The memory 106 comprises a non-transitory portion that embeds one or more applications for execution by the CPU 104. In embodiments, the memory 106 embeds an operating system (OS) 108, and one or more client applications 113. In an embodiment, the OS 108 comprises executable instructions of an OS kernel of the UE 102. In an embodiment, the OS 108 may be executed to perform operations such as, for example, operations to manage input/output data requests to the UE 102 (e.g., from client applications 113), translate the requests into instructions (e.g., data processing instructions) for execution by the CPU 104 or other components of the UE 102, manage the UE 102 resources, such as the CPU 104 and the memory 106 when executing and providing services to applications on the UE 102 such as client applications 113. In an embodiment, client applications 113 may be third-party applications that are configured to send and receive messages including text, audio, video, and other similar communications from UE 102 using the first communication network 116 or the second communication network 118 to UE devices 120. In examples, client applications 113 may include software applications to perform specific user-related communication tasks such as, for example, a GUI to create data requests and translate the requests into instructions, and translate received data into a strategic dashboard scorecard for viewing on the GUI, or may perform user-related telecommunication tasks such as, for example, electronic mail (email) applications like OUTLOOK and GMAIL, web conference applications like ZOOM and WEBEX, and social networking applications such as LINKEDIN, FACEBOOK, or other similar applications.

The UE 102 may be communicatively coupled to first communication network 116 and to second communication network 118. In an example, the UE 102 may be wirelessly coupled to the cell site 114 for connecting the UE 102 to second communication network 118 and/or may be coupled to first communication network 116 via a wired connection or via a wireless connection via gateway 115. In an embodiment, the RF transceiver 111 may establish a radio communication link to the first communication network 116 via a wireless gateway 115 using the antenna 103.

In an example, the first communication network 116 comprises the Internet. In an example, the communication link may be established according to a wireless network protocol that includes the IEEE 802.11 (WIFI) protocol. In an embodiment, the RF transceiver 111 includes RF circuits that provide an air interface for the UE 102. While not shown in FIG. 1, the RF transceiver 111 may include additional circuit components to process and manipulate wireless signals that are received from the wireless gateway 115. In an example, the second communication network 118 may be a 5G core network (e.g., a macro network) of a network provider/MNO, and the first communication network 118 may be a data network such as the Internet. In an embodiment, the UE 102 may request AAA services of the second communication network 118 using the radio communication link. In examples, the communication link between the second communication network 118 and UE 102 may be established according to an LTE protocol, a CDMA protocol, a GSM protocol, or a 5G telecommunication protocol. The second communication network 118 may provide 5G services including voice, data, and messaging services to the UE 102 using virtual network functions. The performance measurement system 100 may comprise additional communication networks similar to second communication network 118 and any number of cell sites 114.

In an example, the UE 120 may be communicatively coupled to second communication network 118. In an example, the UE 120 may be associated with a user that creates an initiative (also referred to as a “project”) on enterprise tools 125 at application server 124. In an example, application server 124 may store a plurality of enterprise software 125 that may be accessed by UE 102 or UE 120 for creating initiatives, inputting data for project progress data, monitoring action steps of initiatives, and requesting a strategic dashboard scorecard of performance measurement scores for business capabilities of KPMs for the organization. In an example, enterprise software or tools (also known as enterprise application software (EAS)) includes software instructions that may be executed by one or more processor to perform steps associated with the instructions. In an example, the UE 120 may use enterprise tools 125 to create initiatives with action steps, assign personnel resources from the different business capabilities including assigning individual and team personnel with responsibilities/action to perform, user notes, inputs, and action steps for completing the initiative, and/or performance data to identify key performance indicators that identifies whether progress has been made in meeting or completing the action steps in order to achieve milestones for the initiative. In an example, the UE 120 may store the initiatives at initiatives database 132.

In an example, the UE 120 may be associated with an administrative user. In an example, the administrative user creates and stores configuration information in a configuration database 126. In an example, the configuration database 126 may store dashboard templates that may include objects that are to be presented for viewing on a strategic dashboard scorecard that is created by UE 120. In an example, the objects may include KPMs, initiatives, scoring values for initiatives that are presented for viewing on the strategic dashboard scorecard when the initiatives are implemented. In an example, the dashboard templates may define the objects that are to be presented and analyzed, the scoring values (e.g., a project level scoring) that is to be applied to the initiatives, may include business capabilities that are to be evaluated for the pre-defined KPMs based on the initiatives, and include the rules that are applied to obtain the scoring values for determining performance measurement scores for the KPMs.

In an example, the progress data and model database 128 may receive and store project progress data that are entered into enterprise software/enterprise tools 125 as resources are consumed for an initiative, store scoring rules from a model that are used by performance measurement algorithm of SPM application 123 to obtain performance measurement scores of KPMs including current and historical performance measurement scores of KPMs for business capabilities of the organization. In an example, the performance measurement scores of KPMs including the current and historical performance measurement scores of KPMs for business capabilities of the organization may be stored at KPM database 130 and retrieved by the SPM application 123 and presented for viewing on a strategic dashboard scorecard in a GUI of client application 113.

A strategic performance measurement server 122 may be used to obtain performance measurement scores for KPMs according to a strategic performance measurement framework. In an example, the strategic performance measurement server 122 includes an SPM application/software 123 that is configured with an SPM algorithm comprising software instructions of the SPM application 123 that when executed by one or more processors of the strategic performance measurement server 122 may determine performance measurement scores of business capabilities of the organization, communicate with UE device 120 to communicate configuration information, and communicate with application server 124 to communicate initiatives for storage in initiatives database 132 and project progress data for the initiatives to progress data and model database 128. In another example, the SPM application 123 may be located at UE device 102. The strategic performance measurement server 122 may be configured with software instructions to communicate with several databases such as configuration database 126, progress data and model database 128, KPM database 130, and initiatives database 132. The strategic performance measurement server 122 may also be configured with software instructions to communicate with users on user devices by communicating with UE 102 and UE 120 via a wire, wireless, or Internet connection. The UE devices 102 and 120 may be configured with software instructions to receive data from the strategic performance measurement server 122 and display the data to a user associated with UE 102 or UE 120 via a GUI at the respective UE 102 or UE 120.

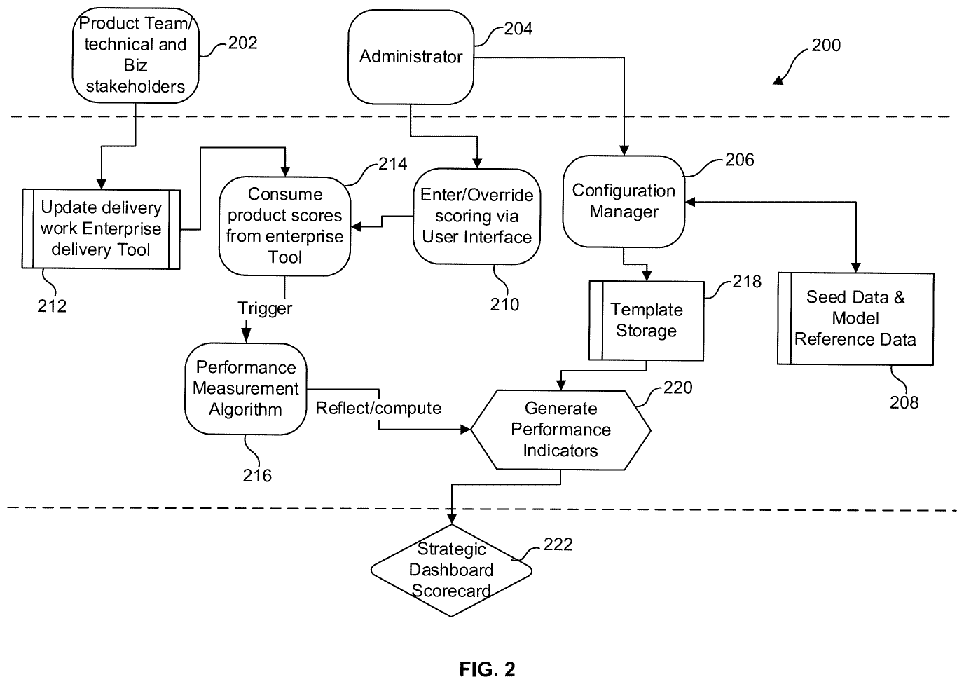

Turning now to FIG. 2, and with continued reference to FIG. 1, a block diagram 200 is described according to an embodiment. In an embodiment, the block diagram 200 implements a strategic performance measurement framework for an organization. In an example, the strategic performance measurement framework is configured to obtain performance indicators of business capabilities/functions over a pre-defined period of time for key performance measures (KPM) as initiatives (e.g., projects) are implemented in the organization. In an example, the initiative may be a business initiative or a technological initiative. In an example, the period of time to implement initiatives may be any user-defined time period such as, for example, a time period of a quarter, a half-year, a year, or longer. In an example, the performance indicators are performance measurement scores for the KPMs (e.g., strategic objectives or goals), and progress (e.g., improvements) made by the business capabilities towards improving the performance measurement scores for the KPM may be tracked for each initiative that impacts the business capabilities of the organization.

In examples, a timeline for completing some initiatives may be different than other initiatives. However, as a business capability may support more than one initiative, completed initiatives may provide performance indicators of business capabilities for a time-period that may extend for all initiatives as they are completed at different time periods which provides insights on performance trends for business capabilities through the time period that covers all initiatives.

In an example, the strategic performance measurement framework implements a strategic performance measurement (SPM) application/software. In an example, the SPM application determines performance measurement scores (e.g., progress indicators) of business capabilities by using a scoring value that is derived for each initiative, and project progress data that is transmitted by enterprise application software (also referred to as “enterprise tool”) on a frequent basis (e.g., daily, or weekly) to a database for storage. In an example, the strategic performance measurement framework may present progress indicators of KPMs for the business capabilities via a strategic dashboard scorecard. In an example, the strategic dashboard scorecard is a standardized scorecard used throughout the organization and may enable a user to efficiently and clearly understand how business capabilities are performing in meeting the KPMs of the organization. In an example, as project progress data changes in real-time, the SPM application may dynamically generate an updated strategic dashboard scorecard without user intervention. Further, multiple KPMs (e.g., strategic objectives) that are user-defined may be selected for display on the strategic dashboard scorecard, and a user or stakeholder may selectively change each strategic dashboard scorecard based on selecting one or more different KPMs to be retrieved and presented in a strategic dashboard scorecard. In an example, the strategic dashboard scorecard may provide insights into how each business capability is performing to meet the KPMs/strategic objectives of the organization via the performance measurement scores, whether business capabilities are moving towards meeting target performance measurement scores for the business objectives, and/or whether remedial actions are appropriate for an initiative including allocating additional resources to the initiative or changing the priority of one or more initiatives for the organization.

At block 202, a user may create an initiative on a UE device. In an example, the UE device may be UE device 102 or UE devices 120 in FIG. 1. In an example, the user may be a member of a product team, a technological team, or a business stakeholder of the organization such as, for example, a subject matter expert (SME) of at least one of a technology, a subject area, a material, a manufacturing process, or a machine. In an example, the initiative may be to develop, for internal customers or external customers of the organization, a product/service, or an improvement to an existing product/service. In an example, the user may create an initiative (also referred to as a “project”) on an enterprise tool by creating the initiative including project information via a GUI of the enterprise tool and transmitting the initiative to the application server. In an example, the application server stores the initiative in an initiative database such as, for example, initiative database 132.

In an example, the user may create the initiative and define action steps for completing the initiative. In an example, the user may assign person and monetary resources of one or more business capabilities of the organization (e.g., resources of a marketing function, a legal function, an IT function) to the action steps. In an example, the user may generate reminders within the enterprise tool that enable the user to track progress of action steps and/or manage resources assigned to the initiative according to a project schedule that tracks and communicates timelines and milestones of the initiative to users in order to obtain expected results. In an example, project progress data for the initiative may be entered into the enterprise tool, which stores the project progress data to a database such as, for example, a progress data and model database 128 (FIG. 1). In an example, the initiative may include pre-defined/pre-determined action steps (e.g., pre-determined by the enterprise tool or user-defined). In examples, the initiatives may be short-term projects (e.g., initiatives that are expected to be implemented within a quarter or half-year) or may be a long-term initiative (e.g., a project that is expected to be implemented over a longer time period than a year).

At block 204, an administrative user may receive a notification request for generating configuring information for an initiative. In an example, the administrative user (hereinafter referred to as “administrator”) may be an SME of the organization and may receive the notification request when the initiative is created. In an example, the notification request may be received from the user via the enterprise tool that was used to create the initiative or via an enterprise tool that includes action steps for implementing the initiative.

In examples, the administrator may identify information for configuring dashboard templates, scoring factors to apply to an initiative, layout, and organization of elements for the strategic dashboard scorecard. In an example, the administrator may identify information and may, in some example, select elements that are to be displayed on the strategic dashboard scorecard, how the elements on the strategic dashboard scorecard are to be arranged, the type of information to be presented in a dashboard templates, a scoring factor for each initiative that will be applied to the initiatives in order to generate scoring values that are obtained from project progress data and mathematical computation, and the initiatives that are to be displayed on the strategic dashboard scorecard. In examples, the administrator may determine the layout of the strategic dashboard scorecard including the elements/objects to display, the strategic performance measurement model/algorithm that will be applied for obtaining performance measurement scores for the KPMs, how to display historical performance measurement scores including displaying performance trends on the improvements made by the business capabilities for KPMs over historical scores as project progress data changes for an initiative. In an example, the administrator may select as many objects (for example, elements, scoring factor, and initiatives), or as few objects to present on the strategic dashboard scorecard.

At block 206, the administrator transmits configuration information to the strategic performance measurement server to configure one or more elements of a dashboard template including defining the layout of the elements that are to be included in the dashboard template. In an example, the elements for configuring the dashboard template include KPMs, performance measurement scores of the selected KPMs, initiatives that have been implemented or are currently pending implementation, the scoring factors that are applied to initiatives to obtain scoring values (e.g., a project level scoring) for each initiative, business capabilities that are being measured, and rules of an SPM algorithm (e.g., a mathematical model) that is executed in the SPM application and which uses a scoring value of an initiative to obtain a performance measurement score for business capabilities by KPMs that performed one or more action steps of the initiative. In an example, the administrator may include KPMs that are generally well-known within the organization and/or KPMs that are widely used in the organization in the dashboard templates. In an example, the organization of the objects on the dashboard templates may define the layout of objects on the strategic dashboard scorecard. In an example, the administrator may refine dashboard templates to add KPMs or remove KPMs. In an example, the administrator may configure the dashboard template to include the KPMs that are selected by a user or pre-defined KPM selected by the administrator.

In an example, the administrator may identify and/or check that the goals/milestones for each initiative are measurable and quantifiable, assign success factors and key performance indicators for each goal, and configure the dashboard templates to use real-time project progress data when deriving scoring values for initiatives in order to present a strategic dashboard scorecard that is enabled for each user who requests performance measurement metrics of one or more initiatives to provide management with real-time insights on initiatives that are directly related to the business unit and how business capabilities are performing to meet the strategic objectives of the organization.

In another example, the administrator may configure specific dashboard templates for the user. In an example, the administrator may configure templates with user-selected/user-defined KPMs that will be presented with their performance measurement scores on the strategic dashboard scorecard. In an example, the administrator may transmit configuration information to the enterprise tool to configure the enterprise tool to provide the user with the ability to select one or more KPMs to be displayed on a strategic dashboard scorecard via a selectable drop-down menu. In an example, the enterprise tool may provide one or more selectable list of KPMs that the user may select for presenting on the strategic dashboard scorecard via a user-selectable drop-down menu and any additional objects that are not standardized in the strategic dashboard scorecard based on configuration information received from the strategic performance management server. In this way, each user may receive a strategic dashboard scorecard that includes the user-defined KPMs that are specific to the business unit of the user so that the user, based on the user-defined KPMs, may be able to obtain real-time insights on initiatives that are directly related to the user's business unit and how the business capabilities are performing in respect to the business unit's initiatives.

In an example, the administrator may configure a scoring factor that is used by the enterprise tool to derive scoring values (e.g., a project level scores) for initiatives when the initiative is completed/implemented. In an example, the scoring factor interrelates a level of effort (LOE) that is expended by a business capability towards performing all action steps for an initiative to a level of impact (LOI) of the initiative on the KPM of the organization (e.g., a value of the initiative to the organization's strategic goals) when the initiative is closed (e.g., completed or when the initiative is abandoned prior to its completion). In examples, the administrator may input milestones/goals to be achieved for determining the scoring values for the initiative and/or other quantifiable success factors for the initiative (e.g., an indicator that action items for the initiative have been completed). In an example, the administrator may assign the scoring values to a numerical score. In an example, the scoring value may be based on a scoring factor that uses an increasing scale of L, M, or H for an increasing LOE that is needed to achieve the business capabilities and for increasing LOI obtained on the business capabilities when the initiative is completed. In an example, the level of LOE and LOI may be mapped to the numerical score. In an example, the LOI attributed to the initiative may be related to whether the initiative is to develop a product or service for an external customer, or for a product or service for an internal program that is not customer-related or customer-focused and which adds a quantifiable value to the organization. For instance, a product or service may improve the KPM of configurability with respect to implementing system variation for effort inputted into the product or service, may improve the KPM of customer experience when using the product or service, and/or may improve the KPM of reducing operating cost to maintain daily operations to the organization.

In an example, the administrator may configure scoring values for the initiatives by mapping the scoring factors to a numerical score. In an example, the scoring factors of L, M, H for LOE and LOI are mapped to a numerical score. In an example, the numerical score may be assigned to a pre-defined range such as, for example, a range between 0.1 and 0.5 or between 1 and 10, with a higher numerical score indicating a higher value of the initiative to the organization (e.g., a degree of a LOE for a particular LOI, and a degree of LOI for a particular LOE). In an example, the administrator may identify formulas to derive scoring values based on weights assigned to the LOE and the LOI for each initiative when the initiative is completed. In an example, the scoring values enable a business unit to assess whether implementing an initiative has a higher LOE in achieving an intended result, or whether, for a specific LOE that is expended, does the initiative have a greater LOI on the strategic goals of the organization as measured by the several KPMs. In an example, the LOE and the LOI may be defined by the administrator. In an example, the strategic performance management server may transmit the configuration information to the configuration database for storage.

At block 208, the strategic performance measurement server may store, to the progress and data model database, the dashboard templates and, for KPMs of business capabilities for one or more initiatives, current performance measurement scores for all KPMs, historical performance measurement scores for all KPMs, target performance measurement scores for all KPMs, and project progress data for initiatives that are received in real-time from the enterprise tools.

At block 210, the administrator may enter scoring values for an initiative to override derived scoring values that are generated by the enterprise tool from the scoring factor. In an example, the administrator may override a scoring value that has been initially derived for an initiative when the initiative is completed based on project resources that were initially assigned to the initiative at the beginning of the period and has changed when the initiative was completed. For instance, the administrator may override a scoring value (for example, input an override scoring value) that is assigned to an initiative when, over the course of the time-period for completing the initiative, resources that were allocated to the initiative changed causing a corresponding change to the LOE and/or the LOI. In another example, the administrator may override a scoring value when the enterprise tool has not received project progress data for the initiative from a user after the initiative has been completed such as, for example, when the action items for an initiative have been completed but the user has not indicated in the enterprise tool that the initiative has been completed. In an example, the administrator may override the initial scoring according to the scoring factors of low (L), medium (M), or high (H) scale that is used to obtain the mapping to the scoring value for an initiative, and which automatically overrides the initial mapping to a numerical number. In an example, the strategic performance measurement server may transmit the administrator-defined scoring values to the strategic performance measurement server, which stores the scoring values in configuration database.

At block 212, project progress data is obtained for an initiative when milestones or goals are completed for the initiative, and a user enters the project progress data into the enterprise tool. In an example, the project progress data is stored in the progress data and model database. In an example, business or technological users may enter project progress data into one or more enterprise tools such as, for example, a project management tool or a finance tool, in real-time as action steps of an initiative are updated and/or completed. In an example, each enterprise tool within the organization is integrated, and project progress data that is created on one enterprise tool is stored in the progress data and model database and shared with other enterprise tools. In an example, the project progress data is transmitted from the enterprise tool to the progress data and model database for storage.

At block 214, scoring values are assigned to the initiative. In an example, as action steps are completed by business capabilities and the initiative is closed, scoring values are automatically derived by the enterprise tool based on a scoring factor (e.g., the LOE and LOI scoring factor of a mathematical model) that was pre-configured by the administrator. In an example, the enterprise tool may retrieve the scoring factor from the configuration database and the project progress data from the progress data and model database and derive the scoring value. In an example, the scoring value that is automatically derived may be replaced by the administrator generated scoring value based on changing resources and timelines that was initially assigned at the start of implementation of an initiative, a change to an LOE, and/or a change to an LOI, or the initiative has been completed but an indicator flag is not selected to indicate the initiative is closed. In an example, a user (e.g., an administrator or a business or technological user) may select a “flag” or other “indicator” when the initiative is completed. In an example, the flag is an indicator in the enterprise tool that the initiative is completed. In response to selecting the indicator flag, the enterprise tool will be triggered to send a notification message or communication to the SPM application indicating that the initiative is completed. In an example, the trigger may further cause the enterprise tool to derive a scoring value for the initiative. In an example, the enterprise tool may retrieve the scoring factor from the configuration database, the project progress data from the progress data and model database and derive the scoring value for an initiative using the scoring factor and the project progress data. In an example, the enterprise tool may apply the derived scoring values to the initiative if an overridden scoring value is not found in the configuration database.

At block 216, the SPM application executes a performance measurement algorithm when an initiative is completed. In an example, the flag automatically triggers the enterprise tool to send the notification request that instructs the SPM application to generate a strategic dashboard scorecard. In an example, the SPM application may execute the performance measurement algorithm to obtain data for populating a dashboard template in order to generate the strategic dashboard scorecard. In an example, when an initiative has not completed and a trigger is not generated, a user may transmit a request via a GUI to the performance management server to generate a strategic dashboard scorecard for current and/or historical initiatives (e.g., initiatives that are not active for the current time-period). In an example, the request may be transmitted directly to the strategic performance management server from the GUI at the UE (for example, UE 102 or UE 120) or may be transmitted to the strategic performance management server from an enterprise tool that received the request from a GUI of the enterprise tool.

In an example, in response to receiving the notification from the enterprise tool, the SPM application may retrieve project progress data for the initiative/project from the progress data and model database, retrieve a dashboard template from the progress data and model database, retrieve scoring rules from the progress data and model database, and apply the performance measurement algorithm to obtain performance measurement scores of KPMs including current and historical performance measurement scores of KPMs for business capabilities of the organization. In an example, the SPM application may analyze the project progress data of completed initiatives and the performance measurement scores of KPMs of completed initiatives in order to determine bottlenecks that were present during the time period for completing the initiative that caused the performance measurement scores of KPMs for the business capabilities. In an example, a bottleneck of an initiative is an action step that has stalled or is holding up/interrupting subsequent action steps to be performed in a timely manner from an original project plan of the initiative.

In an example, the SPM application may automatically send, to one or more enterprise tools, status information on resources that were consumed/used by a completed initiative and may instruct the enterprise tools to assign new resources/reallocate existing resources that are assigned to action steps and timelines of ongoing initiatives. In an example, the SPM application may analyze project progress data for a completed initiative and the strategic dashboard scorecard to determine whether business capabilities assigned to the completed initiative were bottlenecks during implementation of the completed initiative. In an example, the SPM application may automatically change/amend action steps of the ongoing initiative by assigning new resources/reallocating existing resources for action steps of an ongoing initiative within an enterprise tool to avoid bottlenecks in the ongoing initiative. For instance, the SPM application may retrieve project progress data of ongoing/existing initiatives (e.g., initiatives that have not completed) and business capabilities that are assigned to action steps of ongoing initiatives. In an example, the business capabilities of ongoing initiatives were shared resources of completed initiatives. In an example, the SPM application may automatically identify ongoing initiatives that use the resources of a business capability for the completed initiative during the analysis. In an example, the SPM application may identify a potentially latent bottleneck or an actual bottleneck in an ongoing initiative that may need additional resources to be assigned, which enables the enterprise to address the bottleneck early in a project execution process. In an example, the additional resources for the ongoing initiative, if not assigned or allocated, may cause the value added by the initiative to the organization to diminish when completed. In an example, SPM application may determine to assign more people to work on a project based on a low performance measurement score in the strategic dashboard scorecard for progress on that initiative, determine to hire more people to work on an initiative, determine to increase a budget for an initiative, or determine to move resources from one initiative into a second different initiative.

In an example, the SPM application may automatically reallocate resources (for example, add additional resources) to one or more action steps of an existing initiative such as, for example, to initiatives that have a higher LOI based on a lower LOE to obtain revised action steps of an amended initiative. In an example, the SPM application may push the revised action steps for the amended initiative to one or more enterprise tools for implementation without requiring project managers and other users to assess whether an ongoing initiative will add value to the organization using time and effort to identify potential bottlenecks by using metrics data that is generated (for example, project progress data) for a completed initiative. In an example, the SPM application may automatically send the revised action steps of an ongoing initiative that includes the additional allocated resources for implementation to one or more enterprise tools that reduces the bottlenecks in the ongoing initiative. In an example, the additional resources to permit/enable a user (for example, a project manager) of the ongoing initiative to manage ongoing initiatives that include revised action steps (for example, with reallocated business capabilities and capital resources) that are determined using real-time and/or timely project progress data of completed initiatives without having to expend additional computer resources of enterprise tools to analyze completed initiatives in order to meet the strategic objectives of the organization in implementing all initiatives.

At block 218, the SPM application retrieves a static template from template storage. In an example, the SPM application may retrieve a dashboard template that was configured by the administrator based on pre-defined elements or user selected elements from a user, and includes a layout in a table view of objects/elements that are selected by a user or pre-defined by the administrator. In an example, the dashboard template is a static template that will be sent to the user as a strategic dashboard scorecard when the elements of the dashboard template are populated with scoring values and performance measurement scores. In an example, the dashboard template may present a static view of initiatives that are planned and ongoing, scoring rules that are being applied to obtain scoring values for completed initiatives, and performance measurement scores that are applied to KPMs for business capabilities of the organization. In an example, the dashboard template is populated with the scoring values that are obtained for the initiatives, a performance measurement score for a KPM of a business capability for the current time period, performance measurement score for a KPM of a business capability for a prior time period, a target performance measurement score for a KPM of a business capability for the current time period, and a difference between a performance measurement score for a KPM of a business capability for the current time period and a performance measurement score for a KPM of a business capability for the previous time period.

At block 220, the SPM application populates the static template with calculated values that are obtained by the SPM application. In an example, the SPM application populates the static template with calculated values for performance measurement scores of KPM, scoring values of completed initiatives, and any additional user-defined information that was pre-selected by a user for viewing on the strategic dashboard scorecard. In an example, KPMs that are selected by a user for display are based on the initiatives that are selected by a user and/or completed initiatives.

At block 222, the SPM application presents a strategic dashboard scorecard to a user. In an example, a user of SPM application may receive data/information that represents a strategic dashboard scorecard and that is to be displayed on the GUI. The strategic dashboard scorecard is a static view that presents/displays the initiatives and performance measures of the KPMs for the business capabilities of the organization and trend data that shows progress towards improvement of the business capabilities for the different KPMs that are presented on the strategic dashboard scorecard.

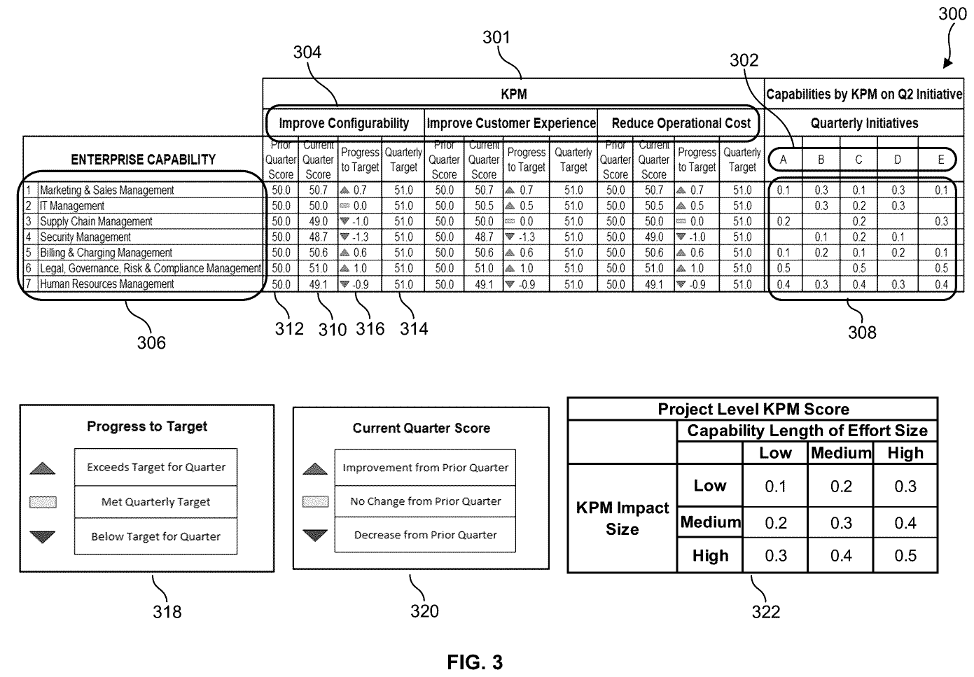

FIG. 3 depicts a table view 300 of a strategic dashboard scorecard that is presented to a user device according to an embodiment. In an example, the user device is UE 102 or UE 120 (FIG. 1). In an example, the table view 300 of a strategic dashboard scorecard is a static table that defines locations of objects at pre-defined locations on the static table based on configuration information that is entered by an administrator, and includes a performance measurement table 301, a progress to target legend 318, a current quarter score legend 320, and a KPM scoring factor legend 322. The strategic dashboard scorecard provides insights into the health of the organization by organizing performance data of KPMs that is calculated for business capabilities after initiatives are implemented in the organization. In an example, the table view 300 presents a view of initiatives that are completed and/or ongoing 302, KPMs that are selected by a user for presentation 304, the business capabilities that are being evaluated in the organization 306, scoring values for completed initiatives 308, performance measurement scores of each KPM that is being presented that includes performance measurement scores for a current KPM score by business capability 310, a prior period KPM score by business capability 312, a target KPM score by business capability 314, progress to target KPM score by business capability 316. In an example, the strategic dashboard scorecard illustrates that, for the KPM of “Improve Configurability”, a current KPM score for security management is 48.7, a prior period KPM score for security management is 50.0, a target KPM score for security management is 51.0, and progress to target KPM score for security management is −1.3, for the KPM of “Improve Customer Experience”, a current KPM score for security management is 48.7, a prior period KPM score for security management is 50.0, a target KPM score for security management is 51.0, and progress to target KPM score for security management is −1.3, and for the KPM of “Reduce Operational Cost”, a current KPM score for security management is 49.0, a prior period KPM score for security management is 50.0, a target KPM score for security management is 51.0, and progress to target KPM score for security management is −1.0. Further, the scoring values for all completed initiatives for the security management business capability are either 0.1 or 0.2, which indicates a low LOE and a low LOI. In an example, a user viewing the strategic dashboard scorecard for the security management business capability may determine that the security management business capability has not met performance measurement scores for any of the KPMs and the initiatives may not need to be continued in the next quarter.

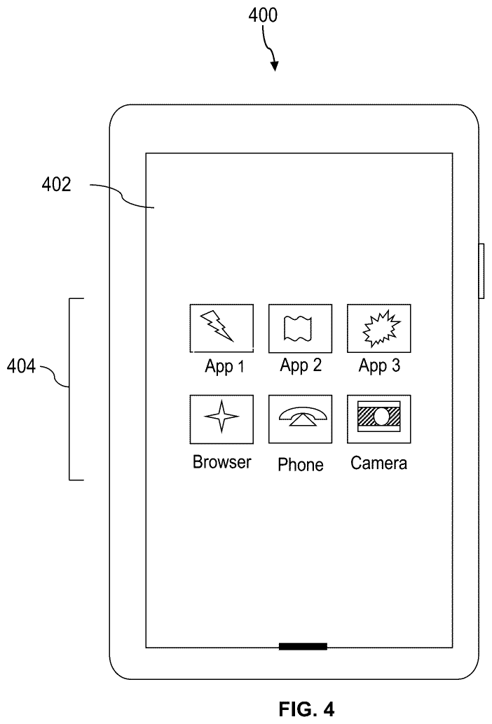

FIG. 4 depicts user equipment (UE) 400, which is operable for implementing aspects of the present disclosure, but the present disclosure should not be limited to these implementations. Though illustrated as a communication device, the UE 400 may take various forms including a smart phone, a tablet computer, a portable computer, a desktop computer, a wearable computer, a personal digital assistant (PDA), a headset computer, a laptop computer, a notebook computer, and a tablet computer.

The UE 400 includes a touchscreen display 402 having a touch-sensitive surface for input by a user. A small number of application icons 404 are illustrated within the touch screen display 402. It is understood that in different embodiments, any number of application icons 404 may be presented in the touch screen display 402. In some embodiments of the UE 400, a user may be able to download and install additional applications on the UE 400, and an icon associated with such downloaded and installed applications may be added to the touch screen display 402 or to an alternative screen. The UE 400 may have other components such as electro-mechanical switches, speakers, camera lenses, microphones, input and/or output connectors, and other components as are well known in the art. The UE 400 may present options for the user to select, controls for the user to actuate, and/or cursors or other indicators for the user to direct. The UE 400 may further accept data entry from the user, including numbers to dial or various parameter values for configuring the operation of the handset. The UE 400 may further execute one or more software or firmware applications in response to user commands. These applications may configure the UE 400 to perform various customized functions in response to user interaction. Additionally, the UE 400 may be programmed and/or configured over-the-air, for example from a wireless base station, a wireless access point, or a peer UE 400. The UE 400 may execute a web browser application which enables the touch screen display 402 to show a web page. The web page may be obtained via wireless communications with a base transceiver station, a wireless network access node, a peer UE 400 or any other wireless communication network or system.

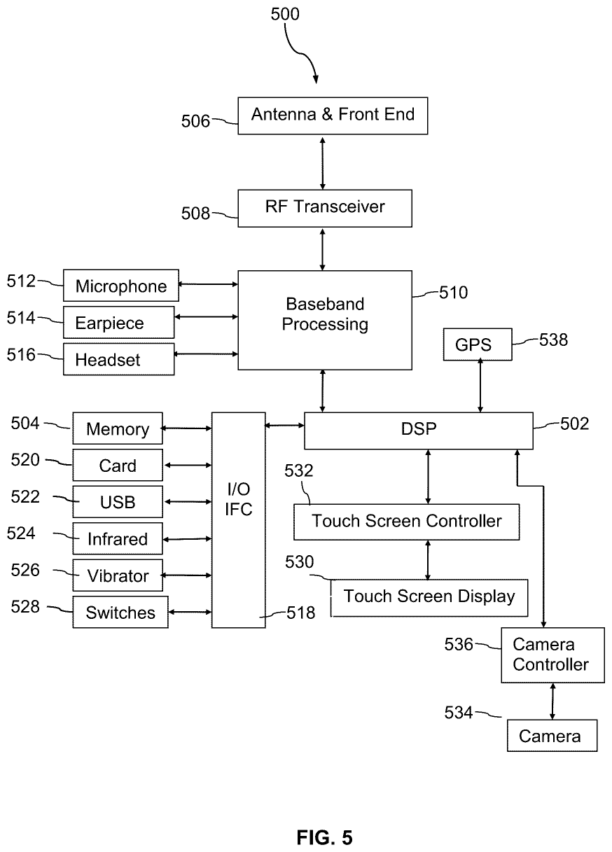

FIG. 5 shows a block diagram of the UE 500. While a variety of known components of a communication device are depicted, in an embodiment a subset of the listed components and/or additional components not listed may be included in the UE 500. The UE 500 includes a digital signal processor (DSP) 502 and a memory 504. As shown, the UE 500 may further include one or more antenna and front end unit 506, a one or more radio frequency (RF) transceiver 508, a baseband processing unit 510, a microphone 512, an earpiece speaker 514, a headset port 516, an input/output (I/O) interface 518, a removable memory card 520, a universal serial bus (USB) port 522, an infrared port 524, a vibrator 526, one or more electro-mechanical switches 528, a touch screen display 530, a touch screen controller 532, a camera 534, a camera controller 536, and a global positioning system (GPS) receiver 538. In an embodiment, the UE 500 may include another kind of display that does not provide a touch sensitive screen. In an embodiment, the UE 500 may include both the touch screen display 530 and additional display component that does not provide a touch sensitive screen. In an embodiment, the DSP 502 may communicate directly with the memory 504 without passing through the input/output interface 518. Additionally, in an embodiment, the UE 500 may comprise other peripheral devices that provide other functionality.

The DSP 502 or some other form of controller or central processing unit operates to control the various components of the UE 500 in accordance with embedded software or firmware stored in memory 504 or stored in memory contained within the DSP 502 itself. In addition to the embedded software or firmware, the DSP 502 may execute other applications stored in the memory 504 or made available via information carrier media such as portable data storage media like the removable memory card 520 or via wired or wireless network communications. The application software may comprise a compiled set of machine-readable instructions that configure the DSP 502 to provide the desired functionality, or the application software may be high-level software instructions to be processed by an interpreter or compiler to indirectly configure the DSP 502.

The DSP 502 may communicate with a wireless network via the analog baseband processing unit 510. In some embodiments, the communication may provide Internet connectivity, enabling a user to gain access to content on the Internet and to send and receive e-mail or text messages. The input/output interface 518 interconnects the DSP 502 and various memories and interfaces. The memory 504 and the removable memory card 520 may provide software and data to configure the operation of the DSP 502. Among the interfaces may be the USB port 522 and the infrared port 524. The USB port 522 may enable the UE 500 to function as a peripheral device to exchange information with a personal computer or other computer system. The infrared port 524 and other optional ports such as a Bluetooth® interface or an IEEE 802.11 compliant wireless interface may enable the UE 500 to communicate wirelessly with other nearby handsets and/or wireless base stations.

In an embodiment, one or more of the radio transceivers is a cellular radio transceiver. A cellular radio transceiver promotes establishing a wireless communication link with a cell site according to one or more of a 5G, an LTE protocol, a CDMA protocol, a GSM protocol. In an embodiment, one of the radio transceivers 508 may comprise a near field communication (NFC) transceiver. The NFC transceiver may be used to complete payment transactions with point-of-sale terminals or other communication exchanges. In an embodiment, each of the different radio transceivers 508 may be coupled to its own separate antenna. In an embodiment, the UE 500 may comprise a radio frequency identify (RFID) reader and/or writer device.

The switches 528 may couple to the DSP 502 via the input/output interface 518 to provide one mechanism for the user to provide input to the UE 500. Alternatively, one or more of the switches 528 may be coupled to a motherboard of the UE 500 and/or to components of the UE 500 via a different path (e.g., not via the input/output interface 518), for example coupled to a power control circuit (power button) of the UE 500. The touch-screen display 530 is another input mechanism, which further displays text and/or graphics to the user. The touch screen LCD controller 532 couples the DSP 502 to the touch screen display 530. The GPS receiver 538 is coupled to the DSP 502 to decode global positioning system signals, thereby enabling the UE 500 to determine its position. In an embodiment, the UE 500 is the UE 102 or UE 120 of FIG. 1 that may include a smart phone, a tablet computer, a portable computer, a desktop computer, a wearable computer, a personal digital assistant (PDA), a headset computer, a laptop computer, a notebook computer, and a tablet computer, and other computing devices.

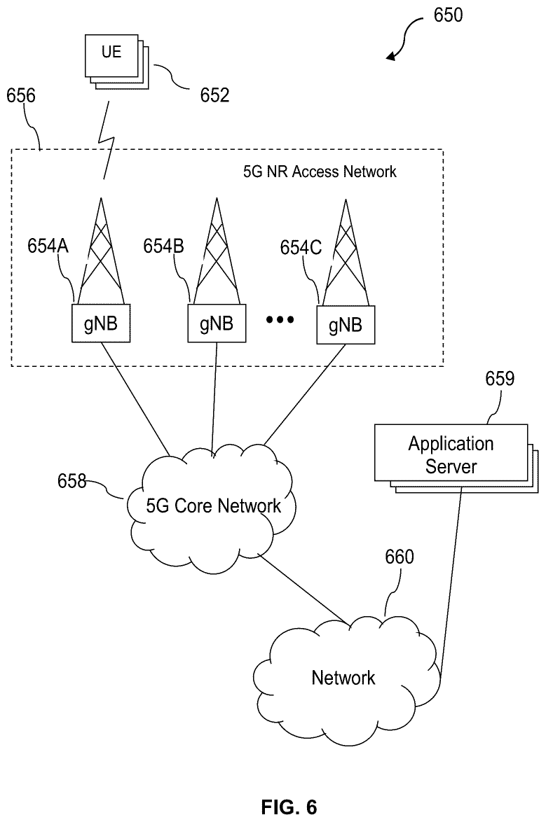

Turning now to FIG. 6, an exemplary communication system 650 is described. Parts of the second communication network 118 described above with reference to FIG. 1 may be implemented substantially like the communication system 650 described in FIG. 6. Typically, the communication system 650 includes a number of access nodes 654A-654C that are configured to provide coverage in which UEs 652 such as cell phones, tablet computers, machine-type-communication devices, tracking devices, embedded wireless modules, and/or other wirelessly equipped communication devices (whether or not user operated), can operate. The UE 652 may be the UE 102 that operate with the 5G communication network 118 (FIG. 1). The access nodes 654A-654C may be said to establish an access network 656. The access network 656 may be referred to as a radio access network (RAN) in some contexts. In a 5G technology generation, an access node 654A-654C may be referred to as a gigabit Node B (gNB). In 4G technology (e.g., long term evolution (LTE) technology) an access node 654A-654C may be referred to as an enhanced Node B (eNB). In 3G technology (e.g., code division multiple access (CDMA) and global system for mobile communication (GSM)) an access node 654A-654C may be referred to as a base transceiver station (BTS) combined with a basic station controller (BSC). In some contexts, the access node 654A-654C may be referred to as a cell site or a cell tower. In some implementations, a picocell may provide some of the functionality of an access node 654A-654C, albeit with a constrained coverage area. Each of these different embodiments of an access node 654A-654C may be considered to provide roughly similar functions in the different technology generations.

In an embodiment, the access network 656 comprises a first access node 654A, a second access node 654B, and a third access node 654C. It is understood that the access network 656 may include any number of access nodes 654A-654C. Further, each access node 654A-654C could be coupled with a 5G core network 658 that provides connectivity with various application servers 659 and/or a network 660. In an embodiment, at least some of the application servers 659 may be located close to the network edge (e.g., geographically close to the UE 652 and the end user) to deliver so-called “edge computing.” The network 660 may be one or more private networks, one or more public networks, or a combination thereof. The network 660 may comprise the public switched telephone network (PSTN). The network 660 may comprise the Internet. With this arrangement, a UE 652 within coverage of the access network 656 could engage in air-interface communication with an access node 654A-654C and could thereby communicate via the access node 654A-654C with various application servers and other entities. In another embodiment, the sub-systems may communicate via the access nodes 654A-654C.

The communication system 650 could operate in accordance with a particular RAT, with communications from an access node 654A-654C to UEs 652 defining a downlink or forward link and communications from the UEs 652 to the access node 654A-654C defining an uplink or reverse link. Over the years, the industry has developed various generations of RATs, in a continuous effort to increase available data rate and quality of service for end users. These generations have ranged from “1G,” which used simple analog frequency modulation to facilitate basic voice-call service, to “4G”-such as LTE, which now facilitates mobile broadband service using technologies such as orthogonal frequency division multiplexing (OFDM) and multiple input multiple output (MIMO).

Recently, the industry has been exploring developments in “5G” and particularly “5G NR” (5G New Radio), which may use a scalable OFDM air interface, advanced channel coding, massive MIMO, beamforming, mobile millimeter wave (mmWave) (e.g., frequency bands above 24 Gigahertz (GHz)), and/or other features, to support higher data rates and countless applications, such as mission-critical services, enhanced mobile broadband, and massive Internet of Things (IoT). 5G is hoped to provide virtually unlimited bandwidth on demand, for example providing access on demand to as much as 20 gigabits per second (Gbps) downlink data throughput and as much as 10 Gbps uplink data throughput. Due to the increased bandwidth associated with 5G, it is expected that the new networks will serve, in addition to conventional cell phones, general internet service providers for laptops and desktop computers, competing with existing ISPs such as cable internet, and also will make possible new applications in internet of things (IoT) and machine to machine areas.

In accordance with the RAT, each access node 654A-654C could provide service on one or more radio-frequency (RF) carriers, each of which could be frequency division duplex (FDD), with separate frequency channels for downlink and uplink communication, or time division duplex (TDD), with a single frequency channel multiplexed over time between downlink and uplink use. Each such frequency channel could be defined as a specific range of frequency (e.g., in an RF spectrum) having a bandwidth and a center frequency and thus extending from a low-end frequency to a high-end frequency. Further, on the downlink and uplink channels, the coverage of each access node 654 could define an air interface configured in a specific manner to define physical resources for carrying information wirelessly between the access node 654A-654C and UEs 652.

Without limitation, for instance, the air interface could be divided over time into frames, subframes, and symbol time segments, and over frequency into subcarriers that could be modulated to carry data. The example air interface could thus define an array of time-frequency resource elements each being at a respective symbol time segment and subcarrier, and the subcarrier of each resource element could be modulated to carry data. Further, in each subframe or other transmission time interval (TTI), the resource elements on the downlink and uplink could be grouped to define physical resource blocks (PRBs) that the access node could allocate as needed to carry data between the access node and served UEs 652.

In addition, certain resource elements on the example air interface could be reserved for special purposes. For instance, on the downlink, certain resource elements could be reserved to carry synchronization signals that UEs 652 could detect as an indication of the presence of coverage and to establish frame timing, other resource elements could be reserved to carry a reference signal that UEs 652 could measure in order to determine coverage strength, and still other resource elements could be reserved to carry other control signaling such as PRB-scheduling directives and acknowledgement messaging from the access node 654A-654C to served UEs 652. And on the uplink, certain resource elements could be reserved to carry random access signaling from UEs 652 to the access node 654A-654C, and other resource elements could be reserved to carry other control signaling such as PRB-scheduling requests and acknowledgement signaling from UEs 652 to the access node 654A-654C.

The access node 654A-654C, in some instances, may be split functionally into a radio unit (RU), a distributed unit (DU), and a central unit (CU) where each of the RU, DU, and CU have distinctive roles to play in the access network 656. The RU provides radio functions. The DU provides L1 and L2 real-time scheduling functions; and the CU provides higher L2 and L3 non-real time scheduling. This split supports flexibility in deploying the DU and CU. The CU may be hosted in a regional cloud data center. The DU may be co-located with the RU, or the DU may be hosted in an edge cloud data center. The Cu may be hosted in user equipment.

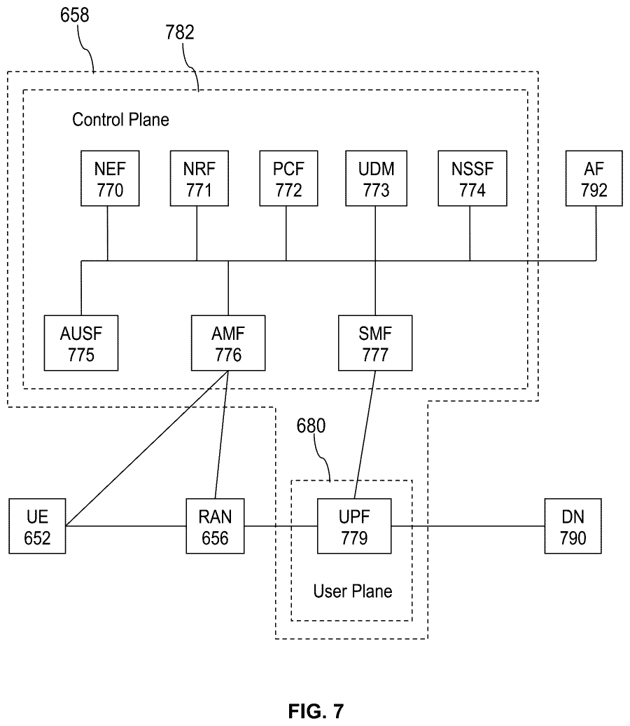

Turning now to FIG. 7, further details of the core network 758 are described. In an embodiment, the core network 758 is a 5G core network. In an embodiment, the core network 658 may be constructed on the communication network 118 (FIG. 1). 5G core network technology is based on a service-based architecture paradigm. Rather than constructing the 5G core network as a series of special purpose communication nodes (e.g., an HSS node, an MME node, etc.) running on dedicated server computers, the 5G core network is provided as a set of services or network functions. These services or network functions can be executed in a private domain environment which supports dynamic scaling and avoidance of long-term capital expenditures (fees for use may substitute for capital expenditures). In an embodiment, these services or network functions may be executed on user equipment such as, for example, executed on the UE 102 of FIG. 1. These network functions can include, for example, a user plane function (UPF) 779, an authentication server function (AUSF) 775, an access and mobility management function (AMF) 776, a session management function (SMF) 777, a network exposure function (NEF) 770, a network repository function (NRF) 771, a policy control function (PCF) 772, a unified data management (UDM) 773, a network slice selection function (NSSF) 774, and other network functions. The network functions may be referred to as virtual network functions (VNFs) in some contexts.

Network functions may be formed by a combination of small pieces of software called microservices. Some microservices can be re-used in composing different network functions, thereby leveraging the utility of such microservices. Network functions may offer services to other network functions by extending application programming interfaces (APIs) to those other network functions that call their services via the APIs. The 5G core network 558 may be segregated into a user plane 780 and a control plane 782, thereby promoting independent scalability, evolution, and flexible deployment.

The UPF 779 delivers packet processing and links the UE 652, via the access node 756, to a data network 790 (e.g., the network 660 illustrated in FIG. 6 or the communication network 118 in FIG. 1). As discussed above, the UE 652 may be the UE 102 that operates with the 5G communication network 118 (FIG. 1). The AMF 776 handles registration and connection management of non-access stratum (NAS) signaling with the UE 552. Said in other words, the AMF 776 manages UE registration and mobility issues. The AMF 776 manages reachability of the UEs 652 as well as various security issues. The SMF 777 handles session management issues. Specifically, the SMF 777 creates, updates, and removes (destroys) protocol data unit (PDU) sessions and manages the session context within the UPF 779. The SMF 777 decouples other control plane functions from user plane functions by performing dynamic host configuration protocol (DHCP) functions and IP address management functions. The AUSF 775 facilitates security processes.

The NEF 770 securely exposes the services and capabilities provided by network functions. The NRF 771 supports service registration by network functions and discovery of network functions by other network functions. The PCF 772 supports policy control decisions and flow-based charging control. The UDM 773 manages network user data and can be paired with a user data repository (UDR) that stores user data such as customer profile information, customer authentication number, and encryption keys for the information. An application function 792, which may be located outside of the core network 558, exposes the application layer for interacting with the core network 558. In an embodiment, the application function 792 may be execute on an application server 559 located geographically proximate to the UE 552 in an “edge computing” deployment mode. The core network 558 can provide a network slice to a subscriber, for example an enterprise customer, that is composed of a plurality of 5G network functions that are configured to provide customized communication service for that subscriber, for example to provide communication service in accordance with communication policies defined by the customer. The NSSF 774 can help the AMF 776 to select the network slice instance (NSI) for use with the UE 652.

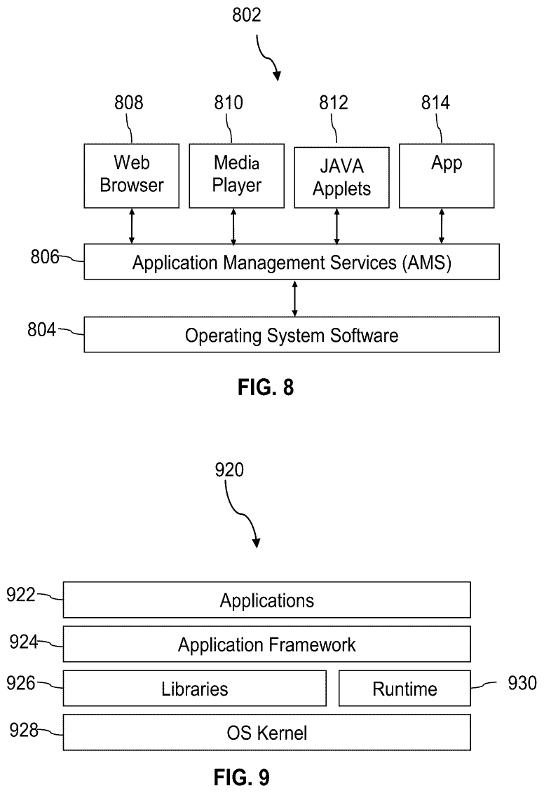

FIG. 8 illustrates a software environment 802 that may be implemented by the DSP 802. The DSP 802 executes operating system software 804 that provides a platform from which the rest of the software operates. The operating system software 804 may provide a variety of drivers for the handset hardware with standardized interfaces that are accessible to application software. The operating system software 804 may be coupled to and interact with application management services (AMS) 806 that transfer control between applications running on the UE 400. Also shown in FIG. 7 are a web browser application 708, a media player application 710, and JAVA applets 712. The web browser application 708 may be executed by the UE 400 to browse content and/or the Internet, for example when the UE 400 is coupled to a network via a wireless link. The web browser application 708 may permit a user to enter information into forms and select links to retrieve and view web pages. The media player application 710 may be executed by the UE 400 to play audio or audiovisual media. The JAVA applets 712 may be executed by the UE 400 to provide a variety of functionality including games, utilities, and other functionality.

FIG. 9 illustrates an alternative software environment 920 that may be implemented by the DSP 502. The DSP 502 executes operating system kernel (OS kernel) 928 and an execution runtime 930. The DSP 502 executes applications 922 that may execute in the execution runtime 930 and may rely upon services provided by the application framework 924. Applications 922 and the application framework 924 may rely upon functionality provided via the libraries 926.

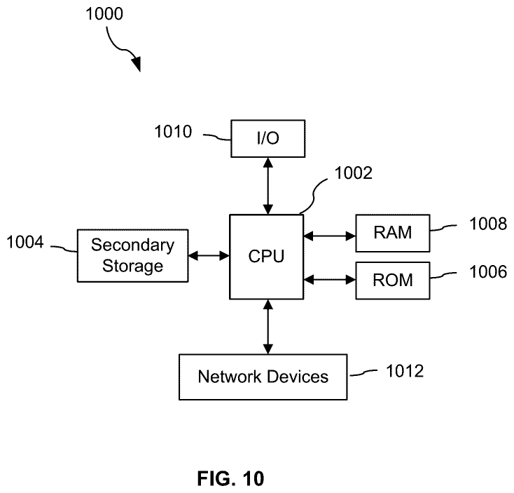

FIG. 10 illustrates a computer system 1000 suitable for implementing one or more embodiments disclosed herein. The computer system 1000 includes a processor 1002 (which may be referred to as a central processor unit (CPU)) that is in communication with memory devices including secondary storage 1004, read-only memory (ROM) 1006, random-access memory (RAM) 1008, input/output (I/O) devices 1010, and network connectivity devices 1012. The computer system 1000 may be UE 102, UE 120, strategic performance management server 122, or application server 124. The processor 1002 may be implemented as one or more CPU chips.

It is understood that by programming and/or loading executable instructions onto the computer system 1000, at least one of the CPU 1002, the RAM 1008, and the ROM 1006 are changed, transforming the computer system 1000 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application-specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 1000 is turned on or booted, the CPU 1002 may execute a computer program or application. For example, the CPU 1002 may execute software or firmware stored in the ROM 1006 or stored in the RAM 1008. In some cases, on boot and/or when the application is initiated, the CPU 1002 may copy the application or portions of the application from the secondary storage 1004 to the RAM 1008 or to memory space within the CPU 1002 itself, and the CPU 1002 may then execute instructions that the application is comprised of. In some cases, the CPU 1002 may copy the application or portions of the application from memory accessed via the network connectivity devices 1012 or via the I/O devices 1010 to the RAM 1008 or to memory space within the CPU 1002, and the CPU 1002 may then execute instructions that the application is comprised of. During execution, an application may load instructions into the CPU 1002, for example load some of the instructions of the application into a cache of the CPU 1002. In some contexts, an application that is executed may be said to configure the CPU 1002 to do something, e.g., to configure the CPU 1002 to perform the function or functions promoted by the subject application. When the CPU 1002 is configured in this way by the application, the CPU 1002 becomes a specific purpose computer or a specific purpose machine.

The secondary storage 1004 is typically comprised of one or more disk drives or tape drives and is used for non-volatile storage of data and as an over-flow data storage device if RAM 1008 is not large enough to hold all working data. Secondary storage 1004 may be used to store programs which are loaded into RAM 1008 when such programs are selected for execution. The ROM 1006 is used to store instructions and perhaps data which are read during program execution. ROM 1006 is a non-volatile memory device which typically has a small memory capacity relative to the larger memory capacity of secondary storage 1004. The RAM 1008 is used to store volatile data and perhaps to store instructions. Access to both ROM 1006 and RAM 1008 is typically faster than to secondary storage 1004. The secondary storage 1004, the RAM 1008, and/or the ROM 1006 may be referred to in some contexts as computer readable storage media and/or non-transitory computer readable media.

I/O devices 1010 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 1012 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 1012 may provide wired communication links and/or wireless communication links (e.g., a first network connectivity device 1012 may provide a wired communication link and a second network connectivity device 1012 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC) and radio frequency identity (RFID). The radio transceiver cards may promote radio communications using 5G, 5G New Radio, or 5G LTE radio communication protocols. These network connectivity devices 1012 may enable the processor 1002 to communicate with the Internet or one or more intranets. With such a network connection, it is contemplated that the processor 1002 might receive information from the network, or might output information to the network in the course of performing the above-described method blocks. Such information, which is often represented as a sequence of instructions to be executed using processor 1002, may be received from and outputted to the network, for example, in the form of a computer data signal embodied in a carrier wave.

Such information, which may include data or instructions to be executed using processor 1002 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 1002 executes instructions, codes, computer programs, scripts which it accesses from hard disk, floppy disk, optical disk (these various disk-based systems may all be considered secondary storage 1004), flash drive, ROM 1006, RAM 1008, or the network connectivity devices 1012. While only one processor 1002 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 1004, for example, hard drives, floppy disks, optical disks, and/or other device, the ROM 1006, and/or the RAM 1008 may be referred to in some contexts as non-transitory instructions and/or non-transitory information.

In an embodiment, the computer system 1000 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 1000 to provide the functionality of a number of servers that is not directly bound to the number of computers in the computer system 1000. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer-usable program code. The computer program product may be embodied in removable computer storage media and/or non-removable computer storage media. The removable computer readable storage medium may comprise, without limitation, a paper tape, a magnetic tape, magnetic disk, an optical disk, a solid-state memory chip, for example analog magnetic tape, compact disk read-only memory (CD-ROM) disks, floppy disks, jump drives, digital cards, multimedia cards, and others. The computer program product may be suitable for loading, by the computer system 1000, at least portions of the contents of the computer program product to the secondary storage 1004, to the ROM 1006, to the RAM 1008, and/or to other non-volatile memory and volatile memory of the computer system 1000. The processor 1002 may process the executable instructions and/or data structures in part by directly accessing the computer program product, for example by reading from a CD-ROM disk inserted into a disk drive peripheral of the computer system 1000. Alternatively, the processor 1002 may process the executable instructions and/or data structures by remotely accessing the computer program product, for example by downloading the executable instructions and/or data structures from a remote server through the network connectivity devices 1012. The computer program product may comprise instructions that promote the loading and/or copying of data, data structures, files, and/or executable instructions to the secondary storage 1004, to the ROM 1006, to the RAM 1008, and/or to other non-volatile memory and volatile memory of the computer system 1000.

In some contexts, the secondary storage 1004, the ROM 1006, and the RAM 1008 may be referred to as a non-transitory computer readable medium or a computer readable storage media. A dynamic RAM embodiment of the RAM 1008, likewise, may be referred to as a non-transitory computer readable medium in that while the dynamic RAM receives electrical power and is operated in accordance with its design, for example during a period of time during which the computer system 1000 is turned on and operational, the dynamic RAM stores information that is written to it. Similarly, the processor 1002 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A system for an information technology framework for measuring performance of business capabilities for a key performance measure (KPM) of an enterprise according to a business initiative, comprising:
a first user equipment configured to:
generate, via a first graphical user interface (GUI), an initiative in an enterprise tool of an application server, wherein the initiative comprises action steps that are to be performed for implementing the initiative;
transmit, via the first GUI, a request for a strategic dashboard scorecard to a strategic performance measurement server; and
receive, via the first GUI, the strategic dashboard scorecard responsive to transmitting the request, wherein the strategic dashboard scorecard comprises a business capability for a KPM, data associated with the business capability for the KPM, and the initiative;
a second user equipment configured to:
receive, via a second GUI, a request for creating configuration information for the initiative from the enterprise tool;
create, via the second GUI, the configuration information for the initiative in response to receiving the request; and
transmit, via the second GUI, the configuration information to the strategic performance measurement server;
the application server configured to:
receive the initiative from the first GUI; and
transmit project progress data of the initiative to a strategic performance measurement server, wherein the project progress data comprises performance data that is obtained during implementation of the initiative; and
the strategic performance measurement server configured to:
assign a scoring value to the initiative;
obtain the strategic dashboard scorecard responsive to assigning the scoring value;
transmit, to the first user equipment, the strategic dashboard scorecard in response to the request for the strategic dashboard scorecard;
analyze at least one of the project progress data and the data associated with the business capability for the KPM; and
automatically transmit, to the enterprise tool, one or more revised action steps for a second initiative whereby the one or more revised action steps permit the enterprise to avoid delays in implementing the second initiative.

2. The system of claim 1, wherein the strategic performance measurement server is configured to:
obtain a dashboard template;
determine a scoring factor for obtaining a scoring value for a project process data; and
input the data into the dashboard template to obtain the strategic dashboard scorecard.

3. The system of claim 2, wherein the strategic performance measurement server is configured to:
derive the scoring value from the scoring factor to obtain a derived scoring value when the initiative includes an indicator; and
assign the derived scoring value to the initiative in the dashboard template.

4. The system of claim 2, wherein the strategic performance measurement server is configured to:
override a scoring value for the initiative that is received from an administrative user associated with the second user equipment to obtain an override scoring value when the initiative does not include an indicator; and
assign the override scoring value to the initiative in the dashboard template.

5. The system of claim 1, wherein the configuration information for the initiative comprises a KPM corresponding to at least one business capability of the enterprise, a performance measurement score for the KPM; a scoring factor applied to the initiative, and a scoring value derived for the initiative based on the scoring factor.

6. The system of claim 1, wherein the first user equipment is configured to:
receive user input for selecting an indicator flag in the enterprise tool when the initiative is completed;
obtain a scoring value in response to the indicator flag; and
send a trigger notification message to a strategic performance measurement (SPM) application from the enterprise tool instructing the SPM application to obtain the data for the strategic dashboard scorecard.

7. The system of claim 6, wherein the SPM application is configured to execute a performance measurement algorithm to obtain the data for the strategic dashboard scorecard in response to the trigger notification message.

8. The system of claim 7, wherein the SPM application is configured to:
in response to the trigger notification message:
obtain project progress data for the initiative;
obtain a dashboard template for one or more KPMs;
obtain scoring rules for the scoring value;
execute the performance measurement algorithm to obtain performance measurement scores of the one or more KPMs; and
input the performance measurement scores into a dashboard template.

9. A method for an information technology framework for measuring performance of business capabilities for a key performance measure (KPM) of an enterprise according to a business initiative, wherein the method comprises:
generating, via a first graphical user interface (GUI) of a first user equipment (UE), an initiative in an enterprise tool of an application server, wherein the initiative comprises action steps that are to be performed for implementing the initiative;
transmitting, via the first GUI, a request for a strategic dashboard scorecard to a strategic performance measurement server;
receiving, via the first GUI, the strategic dashboard scorecard responsive to transmitting the request, wherein the strategic dashboard scorecard comprises a business capability for the KPM, data associated with the business capability for the KPM, and the initiative;
receiving, via a second GUI of a second UE, a request for creating configuration information for the initiative from the enterprise tool;
creating, via the second GUI, the configuration information for the initiative in response to receiving the request;
transmitting, via the second GUI, the configuration information to the strategic performance measurement server;
receiving, by the application server, the initiative from the first GUI;
transmitting, by the application server, project progress data of the initiative to a strategic performance measurement server, wherein the project progress data comprises performance data that is obtained during implementation of the initiative;
assigning, by the strategic performance measurement server, a scoring value to the initiative;
obtaining, by the strategic performance measurement server, the strategic dashboard scorecard responsive to assigning the scoring value;
transmitting, by the strategic performance measurement server, the strategic dashboard scorecard to the first UE in response to the request for the strategic dashboard scorecard;
analyzing, by the strategic performance measurement server, at least one of the project progress data and the data associated with the business capability for the KPM; and
automatically transmitting, to the enterprise tool, one or more revised action steps for a second initiative whereby the one or more revised action steps permit the enterprise to avoid delays in implementing the second initiative.

10. The method of claim 9, further comprising:
obtaining, by the strategic performance measurement server, a dashboard template;
determining, by the strategic performance measurement server, a scoring factor for obtaining a scoring value for a project process data; and
inputting, by the strategic performance measurement server, the data into the dashboard template to obtain the strategic dashboard scorecard.

11. The method of claim 10, further comprising:
deriving, by the strategic performance measurement server, the scoring value from the scoring factor to obtain a derived scoring value when the initiative includes an indicator; and
assigning, by the strategic performance measurement server, the derived scoring value to the initiative in the dashboard template.

12. The method of claim 10, further comprising:
receiving, from an administrative user associated with a second user equipment, an override scoring value;
overriding, by strategic performance measurement server, a scoring value for the initiative with the override scoring value when the initiative does not include an indicator; and
assigning, by strategic performance measurement server, the override scoring value to the initiative in the dashboard template.

13. The method of claim 9, wherein the configuration information for the initiative comprises a KPM corresponding to at least one business capability of the enterprise, a performance measurement score for the KPM, a scoring factor applied to the initiative, and a scoring value derived for the initiative based on the scoring factor.

14. The method of claim 9, further comprising:
receiving, by the first UE, user input for selecting an indicator flag in the enterprise tool when the initiative is completed;
obtaining, by the first UE, a scoring value in response to the indicator flag; and
sending, by the first UE, a trigger notification message to a strategic performance measurement (SPM) application from the enterprise tool instructing the SPM application to obtain data for the strategic dashboard scorecard.

15. The method of claim 14, further comprising executing, by the SPM application, a performance measurement algorithm to obtain the data for the strategic dashboard scorecard in response to the trigger notification message.

16. The method of claim 14, wherein in response to the trigger notification message, the method further comprises:
obtaining, by the SPM application, project progress data for the initiative;
obtaining, by the SPM application, a dashboard template for one or more KPMs;
obtaining, by the SPM application scoring rules for the scoring value;
executing, by the SPM application the performance measurement algorithm to obtain performance measurement scores of the one or more KPMs; and
inputting, by the SPM application, the performance measurement scores into a dashboard template.

17. A system for an information technology framework for measuring performance of business capabilities for a key performance measure (KPM) of an enterprise according to a business initiative, comprising:
a first user equipment (UE) configured to:
generate, via a first graphical user interface (GUI), an initiative in an enterprise tool of an application server, wherein the initiative comprises action steps that are to be performed for implementing the initiative;
transmit, via the first GUI, a request for a strategic dashboard scorecard to a strategic performance measurement server; and
receive, via the first GUI, the strategic dashboard scorecard responsive to transmitting the request, wherein the strategic dashboard scorecard comprises a business capability for the KPM, data associated with the business capability for the KPM, and the initiative;
a second UE configured to:
receive, via a second GUI, a request for creating configuration information for the initiative from the enterprise tool, wherein the configuration information for the initiative comprises a KPM corresponding to at least one business capability of the enterprise, a performance measurement score for the KPM; a scoring factor applied to the initiative, and a scoring value derived for the initiative based on the scoring factor;
create, via the second GUI, the configuration information for the initiative in response to receiving the request; and
transmit, via the second GUI, the configuration information to the strategic performance measurement server;
the application server configured to:
receive the initiative from the first GUI; and
transmit project progress data of the initiative to a strategic performance measurement server, wherein the project progress data comprises performance data that is obtained during implementation of the initiative; and
the strategic performance measurement server configured to:
obtain a dashboard template;
determine a scoring factor for obtaining a scoring value for a project process data;
assign a scoring value for the initiative based on the scoring factor;
input the scoring value to the dashboard template to obtain the strategic dashboard scorecard;
transmit, to the first user equipment, the strategic dashboard scorecard in response to the request for the strategic dashboard scorecard;
analyze at least one of the project progress data and the data associated with the business capability for the KPM; and
automatically transmit, to the enterprise tool, one or more revised action steps for a second initiative whereby the one or more revised action steps permit the enterprise to avoid delays in implementing the second initiative.

18. The system of claim 17, wherein the strategic performance measurement server is configured to:
derive the scoring value from the scoring factor to obtain a derived scoring value when the initiative includes an indicator; and
assign the derived scoring value to the initiative in the dashboard template.

19. The system of claim 18, wherein the strategic performance measurement server is configured to:
override a scoring value for the initiative that is received from an administrative user associated with a second user equipment to obtain an override scoring value when the initiative does not include an indicator; and
assign the override scoring value to the initiative in the dashboard template.

20. The system of claim 17, wherein the first UE is configured to:
receive user input for selecting an indicator flag in the enterprise tool when the initiative is completed;
obtain a scoring value in response to the indicator flag; and
send a trigger notification message to a strategic performance measurement (SPM) application from the enterprise tool instructing the SPM application to obtain data for the strategic dashboard scorecard.
